(19) United States
(12) Patent Application Publication
(10) Pub. No.: US 2003/0054682 A1
(43) Pub. Date: Mar. 20, 2003

(54) Cable reel

(75) Inventor: Shoichi Sugata, Yokkaichi-City (JP)

Correspondence Address: GREENBLUM & BERNSTEIN, P.L.C., 1950 ROLAND CLARKE PLACE, RESTON, VA, 20191, US

(73) Assignee: SUMITOMO WIRING SYSTEMS, LTD., Yokkaichi-City (JP)

(21) Appl. No.: 10/231,032

(22) Filed: Aug. 30, 2002

(30) Foreign Application Priority Data
Sep. 14, 2001 (JP) 2001-279212

(51) Int. Cl. H01R 3/00

(52) U.S. Cl. 439/164

(57) ABSTRACT

A cable reel is provided that has a movable inner sleeve member rotatably coupled to a stationary outer sleeve member. A flat cable is contained in an annular chamber defined between the sleeve members. Connection cases having same configuration are attached to the opposite ends of a flat cable, respectively. An end of a flat cable can be inserted into either side of the connection case. Each end is bent at the right angle and connected to bus bars that are fixed in the connection case beforehand. The flat cable includes a first conductor group having a greater width and a second conductor group having a smaller width. The first and second conductor groups are arranged on the respective side areas divided by the centerline of a width of the flat cable in a conductor-juxtaposing direction.

### CROSS-REFERENCE TO RELATED APPLICATIONS

The present application claims priority under 35 U.S.C. §119 of Japanese Patent Application No. JP 2001-279212 filed on Sep. 14, 2001, the disclosure of which is expressly incorporated by reference herein in its entirety.

### BACKGROUND OF THE INVENTION

1. Field of the Invention

This invention relates to a cable reel to be mounted on a steering device for an automobile.

2. Description of Related Art

For convenience of explanation, a prior art cable reel will be described by referring to FIGS. 6 and 7. FIG. 6 is a cross sectional view of a cable reel. FIG. 7 is an explanatory view of a connecting condition in which a conventional flat cable is connected to lead wires through bus bars in an inner case.

A prior art cable reel, for example, as shown in FIG. 6, includes a stationary member 1 which can be secured to a steering column and a movable member 2 which can be secured to a steering wheel. The movable member 2 is rotatably coupled to the stationary member 1. Two semicircular guide rings 3 are disposed in an annular chamber defined between the stationary member 1 and the movable member 2. A flat cable 5 is contained in the cable reel by turning back the flat cable 5 through two counter-turn spaces or clearances C defined between the two guide rings 3.

The flat cable may be accommodated in the cable reel in a scrolled manner.

Connections between the opposite ends of conductors 5a of the flat cable 5 and external electric wires are shown in FIG. 7. Bus bars 9 are fixed in inner cases 4 and 6 by molding or pressing. The conductors 5a are connected to ends of the bus bars 9 by ultrasonic welding or the like while lead wires L/W of an external circuit are connected to the other ends of the bus bars 9 by ultrasonic welding or the like. Covers 7 are integrally mounted on the inner cases 4 and 6. The inner cases 4 and 6 with the covers 7 are fixed in containing sections 1a and 2a formed in the stationary member 1 and movable member 2, respectively. Alternatively, the inner cases may be over-molded again by insert molding in lieu of utilizing the cover 7.

The flat cable includes juxtaposed conductors made of copper foils or the like and an insulation resin film laminated on the opposite side surfaces of the juxtaposed conductors. The widths of the conductors are different in accordance with the kinds of circuits. That is, conductors for a power circuit such as an air bag have a greater width while conductors for signal circuits have a smaller width. Thus, the conductors are divided into two conductor groups having two different widths. Also, the bus bars are divided into two bus bar groups having two different widths in correspondence with the two conductor groups. Arrangements of the conductor and bus bar groups having the respective different widths are different depending upon arrangements of lead wires on a vehicle frame.

Further, configurations of the inner cases to be connected to the opposite ends of the flat cable are different in correspondence with the containing sections in the stationary member 1 and movable member 2. The configuration of the inner case of the stationary member is different from that of the movable member. Thus, the respective inner cases require special parts for them.

As described above, it is necessary in the prior art to design the inner cases individually and to provide special inner cases, since the conductors of the flat cable have different widths, and the arrangements of the bus bars are different in accordance with the different widths of the conductors. This results in increase in the number of parts and increased costs.

The above problem can be solved, if the widths of the conductors of the flat cable are unified. However, in such case, it is also necessary to unify the widths into the greater width of the conductors for power circuits, i.e., one can make all the conductors wider. However, this results in the upsizing of the flat cable and increases the weight of the cable. Accordingly, a cable reel itself disadvantageously becomes larger in size and disadvantageously increases in weight.

### SUMMARY OF THE INVENTION

In view of the above problem, the present invention aims to provide a cable reel that improves a structure for connecting a flat cable having conductors divided into two conductor groups having a greater width and a smaller width to lead wires of an external electric circuit through bus bars and utilizes same connection cases to be attached to the opposite ends of the flat cable. This enables the same flat cable to be used even if arrangements of the conductors having different widths and the bus bars are inverted on account of a condition of lead wires.

Thus, the present invention is directed to a cable reel wherein a movable inner sleeve member is rotatably coupled to a stationary outer sleeve member. A flat cable is contained in an annular chamber defined between the stationary and movable sleeve members. The flat cable includes a plurality of juxtaposed conductors and an insulation film coating the juxtaposed conductors. The conductors of the opposite ends of the flat cable and external electric wires are connected to bus bars fixed in connection cases, and the connection cases are secured in containing sections provided in the movable and stationary sleeve members, respectively. The cable reel is characterized in that the connection cases have the same parts and are connected to the opposite ends of the flat cable. An end of the flat cable can be inserted into either side of each of the connection cases, bent at a right angle, and connected to the bus bars that are fixed in the connection case beforehand. The conductors of the flat cable include a first conductor group having a greater width for power circuits and a second conductor group having a smaller width for signal circuits. The first and second conductor groups are arranged on the respective side areas divided by a centerline of a width of the flat cable in a conductor-juxtaposing direction. The bus bars are divided into a first bus bar group for power circuits and a second bus bar group for signal circuits. The first and second bus bar groups are arranged laterally in the connection case and the first and second conductor groups can be connected to the first and second bus bar groups.

Each of the connection cases includes a rectangular base plate section having one end that is provided with a flat cable inlet part. The flat cable inlet part includes openings so that the flat cable can enter the inlet part through either the right or the left side of the base plate section. The base plate section is provided on the other end with a fixing part for the bus bars. The fixing part is provided with juxtaposed grooves for the bus bars. The juxtaposed bus bars are forcedly fitted in the grooves.

The bus bars are divided into a first bus bar group having a greater width for use with a power circuit(s) and a second bus bar group having a smaller width for use with a signal circuit(s). The first and second bus bar groups are arranged laterally in the connection case.

According to the above structure and/or arrangement, the flat cable can be inserted into either end of the connection case. In this way, each of the opposite ends of the flat cable can be connected to the connection case. The flat cable can be bent at the right angle at the portion which is inserted in the case. In this way, it is possible to direct the distal ends of the conductors of the flat cable and the bus bars to the same connecting direction. As a result of this arrangement, it is possible to commonly use the connection cases which are attached to the opposite ends of the flat cable and which are mounted in the case containing sections in the stationary and movable members, i.e., a single type of connection case can be used on both ends of the flat cable. In this way, the connection case is designed to receive either end of the flat cable and the connection case can be mounted in either the stationary or the movable parts.

In addition, the conductors of the flat cable can be divided into two groups having the greater and smaller widths. The first conductors with the group having the greater width can be arranged on one side area with respect to the centerline in the width direction of the flat cable while the second conductors with the group having the smaller width can be arranged on the other side area with respect to the centerline. As a result, it is possible to connect the flat cable to the lead wires of the external circuit by using the same connection case while keeping the same arrangement positions of the first and second conductors in the opposite ends of the flat cable when the opposite ends of the flat cable are bent at the right angle and connected to the bus bars in the connection case.

The invention also provides for another cable reel in which the first and second conductors and the bus bars which can be connected to the lead wires of the external wires are counter-changed when the lead wires are changed in arrangement. Accordingly, it is possible to invert the arrangements of the first and second conductors and to share the same flat cable by reversing the flat cable and bending the cable at the right angle.

Thus, it is not necessary to prepare individual special connection cases for each end of the flat cable, and it is possible to reduce numbers of parts and costs. By utilizing the same connection case that is connected to the opposite ends of the flat cable, one can also use the flat cable in more that one kind of a cable reel.

In addition, it is possible to share the same flat cable with another kind of a cable reel. This can reduce kinds of a flat cable that are required and also reduce the cost of the cable reel.

The invention also provides for a cable reel for an automotive steering system, wherein the cable reel includes an outer member configured to be non-movably mounted, an outer containing section which is at least one of coupled to the outer member and arranged within the outer member, an inner member which rotates within the outer member, an inner containing section which is at least one of coupled to the inner member and arranged within the inner member, a flat cable having a first end, a second end and conductors which include at least two parallel conductor groups, the conductors of one of the at least two parallel conductors groups having a first width and the conductors of another of the at least two parallel conductors groups having a second width, wherein the first width is greater than the second width, a first connection case configured to allow the first end of the flat cable to be connected to a first bus bar group, and a second connection case configured to allow the second end of the flat cable to be connected to a second bus bar group. The first and second connection cases are at least one of: interchangeably mountable in each of the inner and outer containing sections, substantially similar to each other, configured to have the same parts, configured to have the same configuration, configured to receive each of the first end and the second end of the flat cable, and configured to be arranged in each of the inner and outer containing sections.

The first and second connection cases may be at least one of: configured to receive each of the first end and the second end of the flat cable and configured to be arranged in each of the inner and outer containing sections. The first and second connection cases may each of: have the same parts, have the same configuration, be configured to receive each of the first end and the second end of the flat cable, and be configured to be arranged in each of the inner and outer containing sections. The flat cable may be arranged in an annular area defined between the outer member and the inner member.

The first connection case may include a first opening configured to receive the first end of the flat cable, whereby the first end can be connected to the first bus bar group. The first connection case may include a second opening configured to receive the second end of the flat cable, whereby the second end can be connected to the second bus bar group. Each of the first and second openings of the first connection case may allow the corresponding first and second ends of the flat cable to be connected to the corresponding first and second bus bar group after being inserted in the corresponding first and second openings and after being oriented at a right angle. Each of the first and second openings may be arranged at a right angle relative to the corresponding first and second bus bar group.

The second connection case may include a first opening configured to receive the first end of the flat cable, whereby the first end can be connected to the first bus bar group.

The second connection case may include a second opening configured to receive the second end of the flat cable, whereby the second end can be connected to the second bus bar group.

Each of the first and second openings of the second connection case may allow the corresponding first and second ends of the flat cable to be connected to the corresponding first and second bus bar group after being inserted in the corresponding first and second openings and after being oriented at a right angle. Each of the first and second openings may be arranged at a right angle relative to the corresponding first and second bus bar group.

Each of the first and second bus bar groups may include some bus bars having a first width and some bus bars having a second width, wherein the first width is greater than the second width. Each of the first and second bus bar groups may include some bus bars which are configured to be connected to a power circuit and some bus bars which are configured to be connected to a signal circuit.

The invention also provides for a cable reel for an automotive steering system, wherein the cable reel includes an outer member configured to be non-movably mounted, an outer containing section which is at least one of coupled to the outer member and arranged within the outer member, an inner member which rotates within the outer member, an inner containing section which is at least one of coupled to the inner member and arranged within the inner member, a flat cable having a first end, a second end and conductors which include at least two parallel conductor groups, the conductors of one of the at least two parallel conductors groups having a first width and the conductors of another of the at least two parallel conductors groups having a second width, wherein the first width is greater than the second width, a first connection case configured to allow the first end of the flat cable to be connected to a first bus bar group, and a second connection case configured to allow the second end of the flat cable to be connected to a second bus bar group, wherein the first and second connection cases are configured to receive each of the first end and the second end of the flat cable and are configured to be arranged in each of the inner and outer containing sections.

The first connection case may include a first opening configured to receive the first end of the flat cable, whereby the first end can be connected to the first bus bar group, the first connection case may also include a second opening configured to receive the second end of the flat cable, whereby the second end can be connected to the second bus bar group, the second connection case may include a first opening configured to receive the first end of the flat cable, whereby the first end can be connected to the first bus bar group, and the second connection case may include a second opening configured to receive the second end of the flat cable, whereby the second end can be connected to the second bus bar group. Each of the first and second openings may be arranged at a right angle relative to the corresponding first and second bus bar group.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a plan view of a flat cable to be used for an embodiment of a cable reel in accordance with the present invention;

FIG. 2 is a plan view of a connection case to be used for an embodiment of a cable reel in accordance with the present invention, illustrating the connection case interconnecting a flat cable and lead wires of an external circuit;

FIG. 3(A) is a schematic plan view of a movable member;

FIG. 3(B) is a schematic plan view of an interior of the movable member, illustrating a connecting condition in which conductors of the flat cable and bus bars in the connection case are interconnected;

FIG. 4(A) is a schematic plan view of a stationary member;

FIG. 4(B) is a schematic plan view of an interior of the stationary member, illustrating a connecting condition in which conductors of the flat cable and bus bars in the connection case are interconnected;

FIG. 5(A) is an explanatory view of a connecting condition in which an arrangement of the bus bars in the connection case is inverted with respect to the right and left sides;

FIG. 5(B) is a partial cross-sectional side view of FIG. 5;

FIG. 6 is a cross sectional view of a prior art cable reel; and

FIG. 7 is an explanatory view of a connecting condition in which a conventional flat cable is connected to lead wires through bus bars in an inner case.

### DETAILED DESCRIPTION OF THE PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

An embodiment of the cable reel in accordance with the present invention will be described below by referring to the drawings.

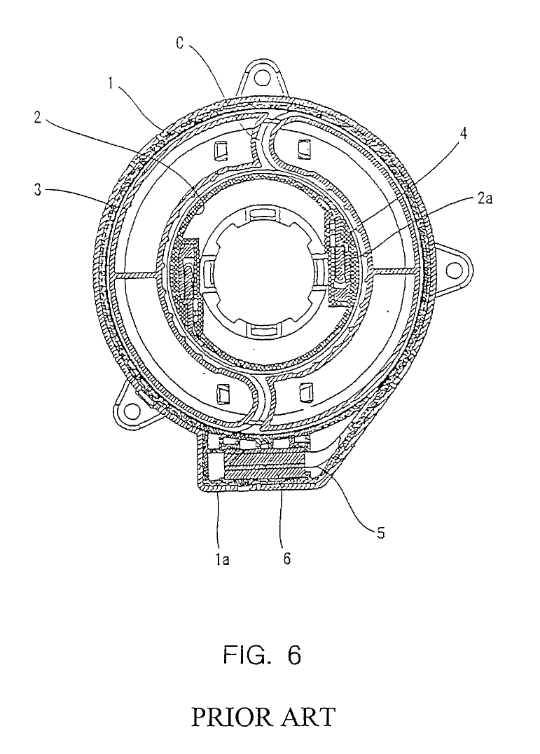

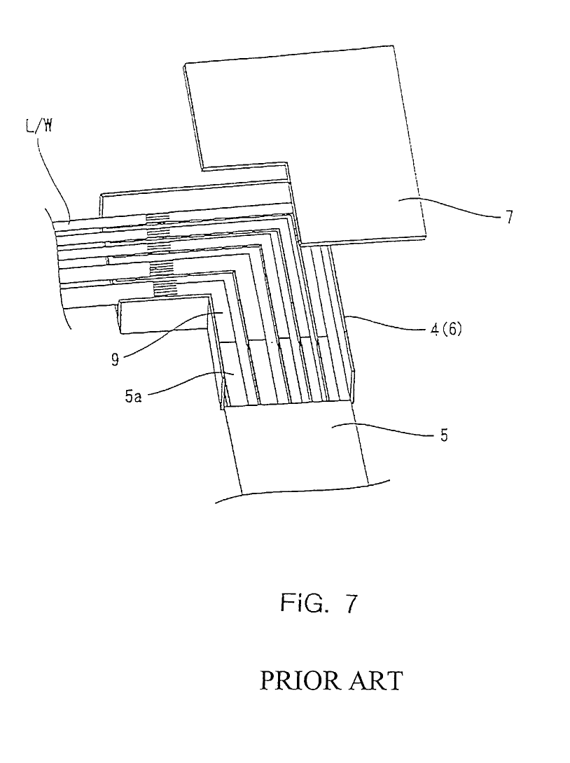

The present invention is applied to the cable reel shown in FIG. 6. Since, accordingly to one embodiment, the cable reel of the present invention is the same as the cable reel shown in FIG. 6 in a general structure, explanations as to the former is omitted here.

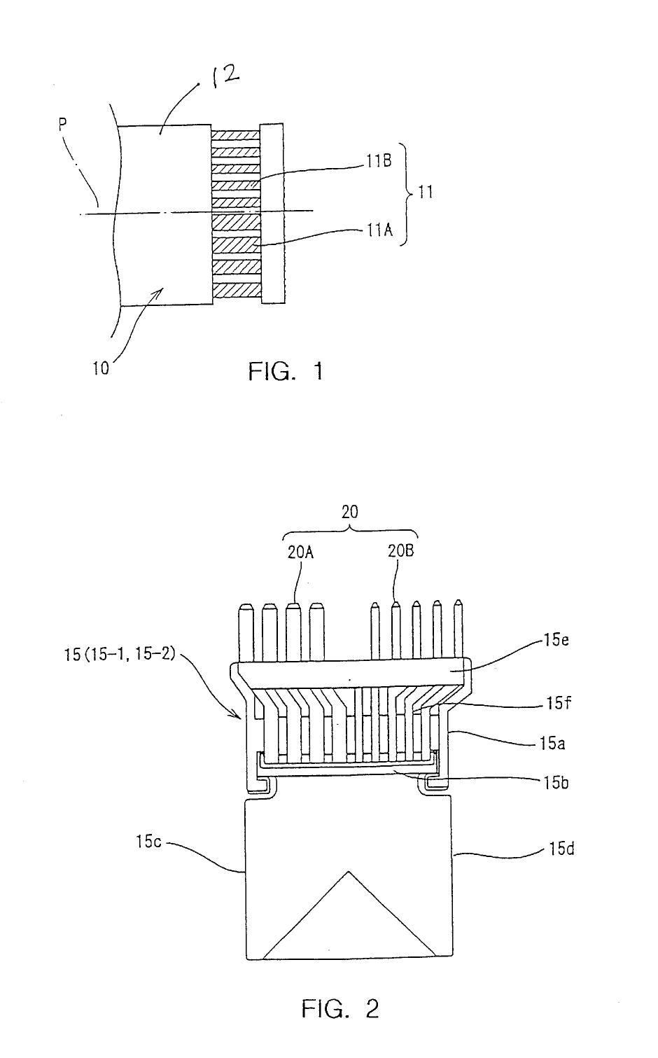

FIG. 1 shows a flat cable 10 that includes juxtaposed conductors 11 made of copper foils and an insulation resin film 12 laminating the opposite side surfaces of the conductors 11.

The conductors 11 include a first conductor group 11A having a greater width for power circuits and a second conductor group 11B having a smaller width for signal circuits. The first and second conductor groups 11A and 11B are arranged on the respective side areas of the flat cable 10 and are divided by the centerline P of a width of the flat cable 10, in a conductor-juxtaposing direction.

Connection cases 15 (15-1, 15-2) are attached to the opposite ends of the flat cable 10, respectively, as shown in FIG. 2. The connection cases 15 are also fitted in containing sections 1a and 2a formed in the stationary member 1 and the movable member 2, respectively. The connection cases 15-1 and 15-2 have the same configurations shown in FIG. 2.

Each connection case 15-1 and 15-2 includes a rectangular base plate section 15a that has an end which includes a flat cable inlet part 15b. The flat cable inlet part 15b is provided with openings 15c and 15d which allow the flat cable 10 to enter the inlet part 15b through either right or left side of a base plate section 15a.

The base plate section 15a is connected with a fixing part 15e which receives the bus bars. The fixing part 15e is provided with juxtaposed grooves 15ffor the bus bars. The juxtaposed bus bars 20 are designed to be forcedly fitted in the grooves 15f. Moreover, the bus bars 20 may be secured in the fixing part 15e by molding or other desirable connecting technique, whether conventional or otherwise.

The bus bars 20 to be secured in the fixing part 15e include a first bus bar group 20A having a greater width for power circuits and a second bus bar group 20B having a smaller width for signal circuits. As shown in FIG. 2, the first bus bar group 20A is arranged on the left side area, while the second bus bar group 20B is arranged on the right side area.

The arrangements of the bus bars 20 in the connection case 15-1 of the stationary member 1 are the same as those in the connection case 15-2 of the movable member 2.

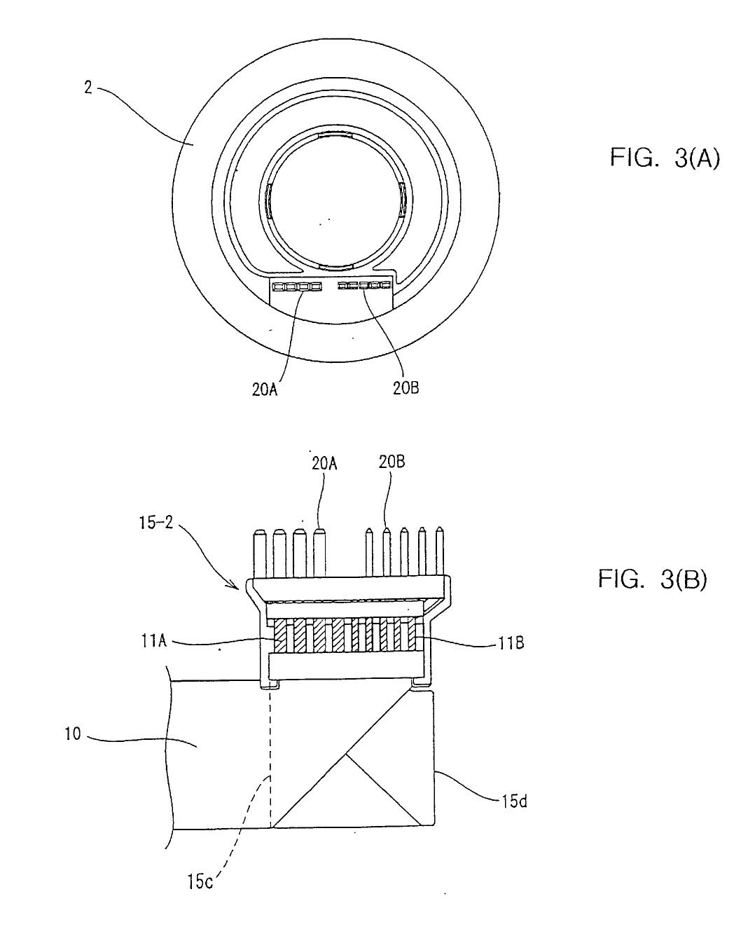

With reference to FIG. 3, it can be seen that the longitudinal opposite ends of the flat cable 10 are bent at the right angle and inserted into the respective connection cases 15-1 and 15-2 from the right side and left side (as necessary) so that the ends of the cable can be connected to the bus bars 20 in the respective connection cases 15-1 and 15-2. The first conductor group 11A that is exposed at the end of the flat cable 10 corresponds with a first bus bar group 20A, while the second conductor group 11B that is exposed at the end of the flat cable 10 corresponds with a second bus bar group 20B.

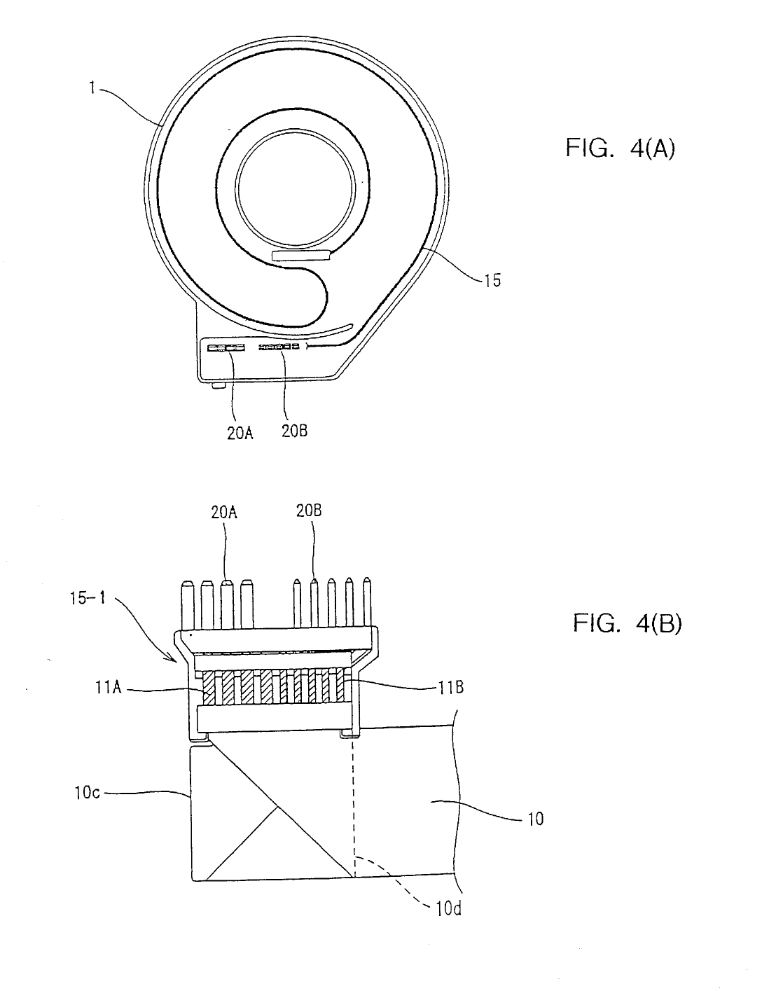

That is, when an end of the flat cable 10 is connected to the connection case 15-2 of the movable member 2 shown in FIG. 3, the first conductor group 11A is disposed at a lower side (or one side) while the second conductor group 11B is disposed at an upper side (or another side). In this regard, one end of the flat cable 10 is inserted into the left side of the connection case 15-2, and then the end is bent at the right angle so that the first conductor group 11A is arranged at the left side while the second conductor group 11B is arranged at the right side (FIG. 3(B)). Consequently, the first and second conductor groups 11A and 11B correspond with the first and second bus bar groups 20A and 20B. On the other hand, when the other end of the flat cable 10 is connected to the connection case 15-1 of the stationary member 1 shown in FIG. 4, the first conductor group 11A is disposed at a lower side (or one side) while the second conductor group 11B is disposed at an upper side (or another side). In this regard, the other end of the flat cable 10 is inserted into the right side of the connection case 15-1, and then it is bent at the right angle so that the first conductor group 11A is arranged at the left side while the second conductor group 11B is arranged at the right side (FIG. 4(B)). Consequently, the first and second conductor groups 11A and 11B correspond with the first and second bus bar groups 20A and 20B.

Thus, the conductors 11 of the flat cable 10 can be connected to the lead wires L/W through the bus bars 20 by using the connection cases 15 which each have the same configuration on the opposite ends of the flat cable 10.

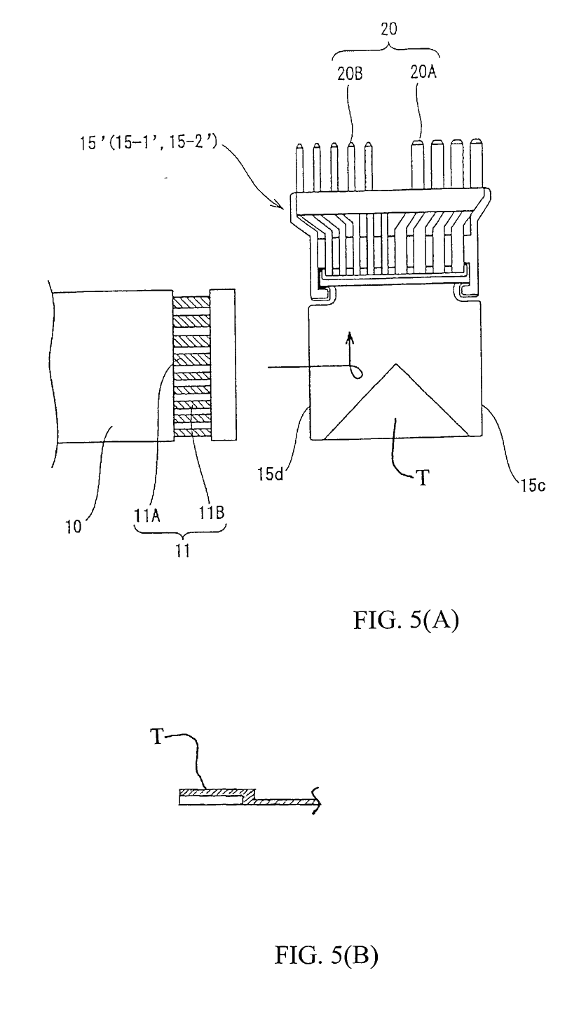

FIGS. 5(A) and (B) show a method of connecting the conductors 11 of the flat cable 10 to the bus bars 20 in the connection cases 15-1′ and 15-2′ in which the arrangements of the first and second bus bar groups 20A and 20B are inverted.

The flat cable 10 is disposed to invert the arrangements of the first and second conductor groups 11A and 11B. The longitudinal opposite ends of the flat cable 10 are bent at a right angle in the same manner described above and assisted by the triangular part T. The conductors 11 are then connected to the bus bars 20. The first conductor group 11A is arranged on the right side area while the second conductor group 11B is arranged on the left side area. Upon inverting of the arrangements of the conductor groups, the first conductor group 11A on the right side area corresponds with the first bus bar group 20A on the right side area while the second conductor group 11B on the left side area corresponds with the second bus bar group 20B on the left side area.

Thus, the same flat cable can be shared between cable reels, even if the conductors are divided into two groups and the arrangements of the conductors are inverted. Moreover, unlike the prior art arrangement which requires a different connection case for each end of the flat cable, the invention provides for a connection case which can be used on both ends of the flat cable.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A cable reel including:
a movable inner sleeve member rotatably coupled to a stationary outer sleeve member, a flat cable contained in an annular chamber defined between the stationary and movable sleeve members;
the flat cable including a plurality of juxtaposed conductors and an insulation film coating the juxtaposed conductors, wherein the conductors located at opposite ends of the flat cable are connected to bus bars fixed in connection cases;
said connection cases being secured in containing sections provided in the movable and stationary sleeve members, respectively;
said connection cases being configured to have the same parts and being configured to be connected to the opposite ends of the flat cable, whereby one end of the flat cable can be inserted into either side of each of said connection cases, and whereby the one end can be bent at a right angle and connected to the bus bars that are fixed in each connection case beforehand; and
the conductors of said flat cable include a first conductor group having a greater width for power circuits and a second conductor group having a smaller width for signal circuits, said first and second conductor groups being arranged on the respective side areas of the flat cable and being divided from one another in a conductor-juxtaposing direction,
wherein the bus bars are divided into a first bus bar group for power circuits and a second bus bar group for signal circuits, the first and second bus bar groups being arranged laterally in a respective connection case, the first and second conductor groups being configured to be connected to the first and second bus bar groups.

2. A cable reel of claim 1, wherein each of said connection cases includes a rectangular base plate section having a flat cable inlet part, said flat cable inlet part having openings so that said flat cable can enter said inlet part through either right or left side of said base plate section, said base plate section being connected with a fixing part for bus bars, said fixing part including juxtaposed grooves for said bus bars, and said bus bars being forcedly fitted in said grooves.

3. A cable reel of claim 1, wherein said bus bars are divided into a first bus bar group having a greater width for power circuits and a second bus bar group having a smaller width for signal circuits, said first and second bus bar groups being arranged laterally in said connection case.

4. A cable reel for an automotive steering system, said cable reel comprising:
an outer member configured to be non-movably mounted;
an outer containing section which is at least one of coupled to said outer member and arranged within said outer member;
an inner member which rotates within said outer member;
an inner containing section which is at least one of coupled to said inner member and arranged within said inner member;
a flat cable having a first end, a second end and conductors which include at least two parallel conductor groups;
the conductors of one of the at least two parallel conductors groups having a first width and the conductors of another of the at least two parallel conductors groups having a second width, wherein said first width is greater than said second width;
a first connection case configured to allow said first end of said flat cable to be connected to a first bus bar group; and
a second connection case configured to allow said second end of said flat cable to be connected to a second bus bar group,
wherein said first and second connection cases are at least one of:
interchangeably mountable in each of said inner and outer containing sections;
substantially similar to each other;
configured to have the same parts;
configured to have the same configuration;
configured to receive each of said first end and said second end of said flat cable; and
configured to be arranged in each of said inner and outer containing sections.

5. The cable reel of claim 4, wherein said first and second connection cases are at least one of:
configured to receive each of said first end and said second end of said flat cable; and
configured to be arranged in each of said inner and outer containing sections.

6. The cable reel of claim 4, wherein said first and second connection cases each of: have the same parts, have the same configuration, are configured to receive each of said first end and said second end of said flat cable, and are configured to be arranged in each of said inner and outer containing sections.

7. The cable reel of claim 4, wherein said flat cable is arranged in an annular area defined between said outer member and said inner member.

8. The cable reel of claim 4, wherein said first connection case comprises a first opening configured to receive said first end of said flat cable, whereby said first end can be connected to said first bus bar group.

9. The cable reel of claim 8, wherein said first connection case comprises a second opening configured to receive said second end of said flat cable, whereby said second end can be connected to said second bus bar group.

10. The cable reel of claim 9, wherein each of said first and second openings of said first connection case allow the corresponding first and second ends of said flat cable to be connected to the corresponding first and second bus bar group after being inserted in the corresponding first and second openings and after being oriented at a right angle.

11. The cable reel of claim 9, wherein each of said first and second openings are arranged at a right angle relative to the corresponding first and second bus bar group.

12. The cable reel of claim 4, wherein said second connection case comprises a first opening configured to receive said first end of said flat cable, whereby said first end can be connected to said first bus bar group.

13. The cable reel of claim 12, wherein said second connection case comprises a second opening configured to receive said second end of said flat cable, whereby said second end can be connected to said second bus bar group.

14. The cable reel of claim 13, wherein each of said first and second openings of said second connection case allow the corresponding first and second ends of said flat cable to be connected to the corresponding first and second bus bar group after being inserted in the corresponding first and second openings and after being oriented at a right angle.

15. The cable reel of claim 13, wherein each of said first and second openings are arranged at a right angle relative to the corresponding first and second bus bar group.

16. The cable reel of claim 4, wherein each of said first and second bus bar groups comprises some bus bars having a first width and some bus bars having a second width, wherein said first width is greater than said second width.

17. The cable reel of claim 4, wherein each of said first and second bus bar groups comprises some bus bars which are configured to be connected to a power circuit and some bus bars which are configured to be connected to a signal circuit.

18. A cable reel for an automotive steering system, said cable reel comprising:
an outer member configured to be non-movably mounted;
an outer containing section which is at least one of coupled to said outer member and arranged within said outer member;
an inner member which rotates within said outer member;
an inner containing section which is at least one of coupled to said inner member and arranged within said inner member;
a flat cable having a first end, a second end and conductors which include at least two parallel conductor groups;
the conductors of one of said at least two parallel conductors groups having a first width and the conductors of another of said at least two parallel conductors groups having a second width, wherein said first width is greater than said second width;
a first connection case configured to allow said first end of said flat cable to be connected to a first bus bar group; and
a second connection case configured to allow said second end of said flat cable to be connected to a second bus bar group, wherein said first and second connection cases are configured to receive each of said first end and said second end of said flat cable and are configured to be arranged in each of said inner and outer containing sections.

19. The cable reel of claim 18, wherein:
said first connection case comprises a first opening configured to receive said first end of said flat cable, whereby said first end can be connected to said first bus bar group, said first connection case comprises a second opening configured to receive said second end of said flat cable, whereby said second end can be connected to said second bus bar group,
said second connection case comprises a first opening configured to receive said first end of said flat cable, whereby said first end can be connected to said first bus bar group, and
said second connection case comprises a second opening configured to receive said second end of said flat cable, whereby said second end can be connected to said second bus bar group.

20. The cable reel of claim 19, wherein each of said first and second openings are arranged at a right angle relative to the corresponding first and second bus bar group.
